(19) United States
(12) Patent Application Publication
(10) Pub. No.: US 2013/0017418 A1
(43) Pub. Date: Jan. 17, 2013

(54) ELECTRODE MATERIAL COMPRISING METAL SULFIDE

(71) Applicants: Arnd GARSUCH, Ludwigshafen (DE); Stefan Herzog, Lambrecht (DE); Lucas Montag, Buerstadt (DE); Andrea Krebs, Mannheim (DE)

(72) Inventors: Arnd GARSUCH, Ludwigshafen (DE); Stefan Herzog, Lambrecht (DE); Lucas Montag, Buerstadt (DE); Andrea Krebs, Mannheim (DE)

(73) Assignee: BASF SE, Ludwigshafen (DE)

(21) Appl. No.: 13/544,332

(22) Filed: Jul. 9, 2012

Related U.S. Application Data
(60) Provisional application No. 61/506,186, filed on Jul. 11, 2011.
(60) Provisional application No. 61/601,068, filed on Feb. 21, 2012.
(60) Provisional application No. 61/618,858, filed on Apr. 2, 2012.

(51) Int. Cl. H01M 4/583; H01M 4/58; H01M 10/056; H01M 4/60

(52) U.S. Cl. 429/50; 429/231.8; 429/213; 429/231.5; 429/223; 429/188; 429/337; 429/341; 429/338; 429/342; 252/506; 252/507

(57) ABSTRACT

The present invention relates to electrode material for an electrical cell comprising as component (A) at least one ion- and electron-conductive metal chalcogenide, as component (B) carbon in a polymorph comprising at least 60% sp²-hybridized carbon atoms, as component (C) at least one sulfur-containing component selected from the group consisting of elemental sulfur, a composite produced from elemental sulfur and at least one polymer, a polymer comprising divalent di- or polysulfide bridges and mixtures thereof, and as component (D) optionally at least one binder. The invention further relates to a rechargeable electrical cell comprising at least one electrode which has been produced from or using the inventive electrode material, to the use of the rechargeable electrical cell and to the use of an ion- and electron-conductive metal chalcogenide for production of an inventive rechargeable electrical cell.

The present invention relates to electrode material for an electrical cell comprising as component (A) at least one ion- and electron-conductive metal chalcogenide, as component (B) carbon in a polymorph comprising at least 60% sp²-hybridized carbon atoms, as component (C) at least one sulfur-containing component selected from the group consisting of elemental sulfur, a composite produced from elemental sulfur and at least one polymer, a polymer comprising divalent di- or polysulfide bridges and mixtures thereof, and as component (D) optionally at least one binder. The invention further relates to a rechargeable electrical cell comprising at least one electrode which has been produced from or using the inventive electrode material, to the use of the rechargeable electrical cell and to the use of an ion- and electron-conductive metal chalcogenide for production of an inventive rechargeable electrical cell.

Secondary batteries, accumulators or rechargeable batteries are just some embodiments by which electrical energy can be stored after generation and used when required. Owing to the significantly better power density, there has been a departure in recent times from the water-based secondary batteries toward development of batteries in which the charge transport in the electrical cell is accomplished by lithium ions.

However, the energy density of conventional lithium ion accumulators which have a carbon anode and a cathode based on metal oxides is limited. New horizons with regard to energy density have been opened up by lithium-sulfur cells. In lithium-sulfur cells, sulfur in the sulfur cathode is reduced via polysulfide ions to S²⁻, which is reoxidized when the cell is charged to form sulfur-sulfur bonds.

Problems, however, are the lack of conductivity of elemental sulfur in the temperature range of −40° C. and 80° C. of interest for electrical vehicles, and the good solubility of the polysulfides, for example Li₂S₄ and Li₂S₆, in the solvents which are part of a liquid electrolyte. The migration of the polysulfide ions from the cathode to the anode, which ultimately leads to the cell death of the electrical cell in question, is also referred to as “shuttling”.

The lack of conductivity of elemental sulfur is eliminated, for example, by addition of conductive carbon to the elemental sulfur, as described in J. Mater. Chem., 2010, 20, 9821-9826. In order to establish the conductivity of sulfur cathodes in solid-state lithium elements, in GB 1 599 792, for example, an ion- and electron-conducive transition metal sulfide such as titanium disulfide was added to the sulfur.

To suppress the unwanted migration of polysulfide ions, the literature proposes, as described in Adv. Mater. 2002, 14, 963-965, the production and use of polymer-sulfur composites and sulfur-containing polymers as cathode materials in rechargeable lithium-sulfur batteries.

The known cathode materials are still unsatisfactory with regard to a combination of required properties such as capacity, cycling stability (lifetime), mechanical stability, resistance to chemicals (solvents, conductive salts), electrochemical corrosion stability and thermal stability. In the development of new cathode materials, the economic viability of the new material in terms of raw material and production costs is also a further important criterion.

It is thus an object of the present invention to provide a cathode material which is easy to produce and which, overall, avoids the disadvantages known from the prior art with regard to various properties.

This object is achieved by an electrode material for an electrical cell comprising
(A) at least one ion- and electron-conductive metal chalcogenide,
(B) carbon in a polymorph comprising at least 60% sp²-hybridized carbon atoms,
(C) at least one sulfur-containing component selected from the group consisting of elemental sulfur, a composite produced from elemental sulfur and at least one polymer, a polymer comprising divalent di- or polysulfide bridges and mixtures thereof, and
(D) optionally at least one binder.

In a preferred embodiment of the inventive electrode material, the proportion of the metal chalcogenide (A) is from 0.1 to 30% and especially from 5 to 20% by weight, the proportion of the carbon (B) from 19 to 50% and especially from 30 to 40% by weight and the proportion of the sulfur-containing component (C) from 20 to 80% and especially from 40 to 60% by weight, where the percentages by weight are each based on the total mass of components (A), (B) and (C).

In a further embodiment, the sum of the proportions by weight of components (A), (B) and (C) is from 50 to 100%, preferably from 80 to 100% and especially from 90 to 100%, based on the total weight of the inventive electrode material.

The ion- and electron-conductive metal chalcogenide present in the inventive electrode material is also called metal chalcogenide (A) or component (A) for short in the context of the present invention. The metal chalcogenide (A) is preferably selected from the group of compounds consisting of CoTe₂, Cr₂S₃, HfS₂, HfSe₂, HfTe₂, IrTe₂, MoS₂, MoSe₂, MoTe₂, NbS₂, NbSe₂, NbTe₂, NiTe₂, PtS₂, PtSe₂, PtTe₂, SnS₂, SnSSe, SnSe₂, TaS₂, TaSe₂, TaTe₂, TiS₂, TiSe₂, TiTe₂, VS₂, VSe₂, VTe₂, WS₂, WSe₂, WTe₂, ZrS₂, ZrSe₂ and ZrTe₂. More preferably, the metal chalcogenide (A) is TiS₂.

In a preferred embodiment of the present invention, the metal chalcogenide (A) at room temperature has an ion and electron conductivity between 10⁻¹⁰ and 10² Ohm⁻¹ cm⁻¹.

The inventive electrode material for an electrical cell further comprises carbon in a polymorph comprising at least 60% sp²-hybridized carbon atoms, preferably from 75% to 100% sp²-hybridized carbon atoms. In the context of the present invention, this carbon is also called carbon (B) or component (B) for short, and is known as such. The carbon (B) is an electrically conductive polymorph of carbon. Carbon (B) can be selected, for example, from graphite, carbon black, carbon nanotubes, graphene or mixtures of at least two of the aforementioned substances.

Figures in % are based on all of the carbon (B) present in the electrode material together with metal chalcogenide (A) and component (C), including any impurities, and denote percent by weight.

In one embodiment of the present invention, carbon (B) is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, carbon (B) is partially oxidized carbon black.

In one embodiment of the present invention, carbon (B) comprises carbon nanotubes. Carbon nanotubes (CNTs for short), for example single-wall carbon nanotubes (SW CNTs) and preferably multiwall carbon nanotubes (MW CNTs), are known per se. A process for preparation thereof and some properties are described, for example, by A. Jess et al. in Chemie Ingenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes can be prepared by processes known per se. For example, a volatile carbon compound, for example methane or carbon monoxide, acetylene or ethylene, or a mixture of volatile carbon compounds, for example synthesis gas, can be decomposed in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon compounds in a light arc, specifically in the presence or absence of a decomposition catalyst.

In one embodiment, the decomposition of volatile carbon compound(s) is performed in the presence of a decomposition catalyst, for example Fe, Co or preferably Ni.

In the context of the present invention, graphene is understood to mean almost ideally or ideally two-dimensional hexagonal carbon crystals of analogous structure to single graphite layers.

In a preferred embodiment of the present invention, carbon (B) is selected from graphite, graphene, activated carbon and especially carbon black.

Carbon (B) may, for example, be in the form of particles having a diameter in the range from 0.1 to 100 μm, preferably 2 to 20 μm. The particle diameter is understood to mean the mean diameter of the secondary particles, determined as the volume average.

In one embodiment of the present invention, carbon (B) and especially carbon black has a BET surface area in the range from 20 to 1500 m²/g, measured to ISO 9277.

In one embodiment of the present invention, at least two, for example two or three, different kinds of carbon (B) are mixed. Different kinds of carbon (B) may differ, for example, with regard to particle diameter or BET surface area or extent of contamination.

In one embodiment of the present invention, the carbon (B) selected is a combination of two different carbon blacks.

In addition, the inventive electrode material for an electrical cell comprises, as well as metal chalcogenide (A) and carbon (B), at least one sulfur-containing component selected from the group consisting of elemental sulfur, a composite produced from elemental sulfur and at least one polymer, a polymer comprising divalent di- or polysulfide bridges and mixtures thereof. The sulfur-containing component is also called component (C) for short in the context of the present invention.

Elemental sulfur is known as such.

Composites produced from elemental sulfur and at least one polymer, which find use as a constituent of electrode materials, are likewise known to those skilled in the art. Adv. Funct. Mater. 2003, 13, 487 ff describes, for example, a reaction product of sulfur and polyacrylonitrile, which results from elimination of hydrogen from polyacrylonitrile with simultaneous formation of hydrogen sulfide.

Polymers comprising divalent di- or polysulfide bridges, for example polyethylene tetrasulfide, are likewise known in principle to those skilled in the art. J. Electrochem. Soc., 1991, 138, 1896-1901 and U.S. Pat. No. 5,162,175 describe the replacement of pure sulfur with polymers comprising disulfide bridges. Polyorganodisulfides are used therein as materials for solid redox polymerization electrodes in rechargeable cells, together with polymeric electrolytes.

In a preferred embodiment of the present invention, component (C) in the inventive electrode material is elemental sulfur.

In a further preferred embodiment of the present invention, component (A) in the inventive electrode material is TiS₂, component (B) carbon black, and component (C) elemental sulfur. The proportion of the TiS₂ is preferably from 0.1 to 30% and especially from 5 to 20% by weight, the proportion of the carbon black from 19 to 50% and especially from 30 to 40% by weight, and the proportion of the elemental sulfur from 20 to 80% and especially from 40 to 60% by weight, the percentages by weight each being based on the total mass of TiS₂, carbon black and elemental sulfur.

In a particularly preferred embodiment of the present invention, the proportion of carbon black in the inventive electrode material is 30 to 40% by weight, based on the total mass of TiS₂, carbon black and elemental sulfur, and the mass ratio of elemental sulfur to TiS₂ is in the range from 60:40 to 95:5, even more preferably in the range from 70:30 to 90:10 and especially in the range from 75:25 to 85:15.

In a likewise preferred embodiment, the sum of the proportions by weight of TiS₂, carbon black and elemental sulfur is from 50 to 100%, preferably 80 to 100%, especially 90 to 100%, based on the total weight of the inventive electrode material. This does not take into account the mass of an output conductor such as a metal foil, for example aluminum foil.

In addition, the inventive electrode material for an electrical cell optionally comprises, as well as metal chalcogenide (A), carbon (B) and component (C), at least one binder, which is also referred to in the context of the present invention as binder (D) for short. Binder (D) serves principally for mechanical stabilization of inventive electrode material.

In one embodiment of the present invention, binder (D) is selected from organic (co)polymers. Examples of suitable organic (co)polymers may be halogenated or halogen-free. Examples are polyethylene oxide (PEO), cellulose, carboxymethylcellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

The mean molecular weight M_{w} of binder (D) may be selected within wide limits, suitable examples being 20 000 g/mol to 1 000 000 g/mol.

In one embodiment of the present invention, the inventive electrode material comprises in the range from 0.1 to 10% by weight of binder, preferably 1 to 8% by weight and more preferably 3 to 6% by weight, based on the total mass of components (A), (B), (C) and (D).

Binder (D) can be incorporated into inventive electrode material by various processes. For example, it is possible to dissolve soluble binders (D) such as polyvinyl alcohol in a suitable solvent or solvent mixture, water/isopropanol for example being suitable for polyvinyl alcohol, and to prepare a suspension with the further constituents of the electrode material. After application to a suitable substrate, the solvent or solvent mixture is removed, for example evaporated, to obtain an electrode composed of the inventive electrode material. A suitable solvent for polyvinylidene fluoride is NMP.

If it is desired to use sparingly soluble polymers as the binder (D), for example polytetrafluoroethylene or tetrafluoroethylene-hexafluoropropylene copolymers, a suspension of particles of the binder (D) in question and of the further constituents of the electrode material is prepared, and processed as described above to give an electrode.

The components (A), (B), (C) and optionally (D) present in the inventive electrode material may, for example, be in a homogeneous mixture with one another. Alternatively, the inventive cathode material may also have a layered structure, in which case at least two layers differ from one another in terms of composition. For example, the inventive cathode material may be composed of a first layer consisting of a homogeneous mixture of components (B), (C) and (D), and of a second layer consisting of a homogeneous mixture of components (A) and (D) or of a homogeneous mixture of components (A), (B) and (D).

Inventive electrode materials are particularly suitable as or for production of electrodes, especially for production of electrodes of lithium-containing batteries, especially rechargeable batteries. The present invention provides for the use of inventive electrode materials as or for production of electrodes for rechargeable electrical cells. The present invention further provides rechargeable electrical cells comprising at least one electrode which has been produced from or using an inventive electrode material as described above.

In one embodiment of the present invention, the electrode in question is the cathode. In the context of the present invention, the electrode referred to as the cathode is that which has reducing action on discharge (operation).

In one embodiment of the present invention, inventive electrode material is processed to give electrodes, for example in the form of continuous belts which are processed by the battery manufacturer.

Electrodes produced from inventive electrode material may, for example, have thicknesses in the range from 20 to 500 μm, preferably 40 to 200 μm. They may, for example, have a rod-shaped configuration, or be configured in the form of round, elliptical or square columns or in cuboidal form, or as flat electrodes.

The electrodes produced with the inventive electrode material may have further constituents customary per se, for example an output conductor, which may be configured in the form of a metal wire, metal grid, metal mesh, expanded metal, metal sheet or a metal foil. Suitable metal foils are especially aluminum foils. A flat output conductor, such as an aluminum foil, can be coated on one side or on both sides with the inventive electrode material.

In one embodiment, a cathode may comprise the inventive electrode material in a layered structure, in which case, for example, an aluminum foil as the output conductor is first coated on one or both sides with a mixture of sulfur, carbon black and binder, and then the first layer applied is sealed with a second layer consisting of titanium sulfide and binder or consisting of titanium sulfide, carbon black and binder.

In one embodiment of the present invention, inventive rechargeable electrical cells comprise, as well as inventive electrode material, at least one electrode comprising metallic magnesium, metallic aluminum, metallic zinc, metallic sodium or preferably metallic lithium.

In a further embodiment of the present invention, above-described inventive rechargeable electrical cells comprise, as well as inventive electrode material, a liquid electrolyte comprising a lithium-containing conductive salt.

In one embodiment of the present invention, inventive rechargeable electrical cells comprise, in addition to inventive electrode material and a further electrode, especially an electrode comprising metallic lithium, at least one nonaqueous solvent which may be liquid or solid at room temperature, and is preferably liquid at room temperature, and which is preferably selected from polymers, cyclic and noncyclic ethers, cyclic and noncyclic acetals, cyclic and noncyclic organic carbonates and ionic liquids.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

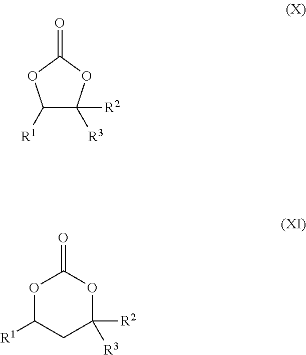

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

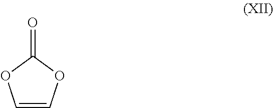

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive rechargeable electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CnF₂F₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:
m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

In one embodiment of the present invention, inventive rechargeable electrochemical cells comprise one or more separators by which the electrodes are mechanically separated. Suitable separators are polymer films, especially porous polymer films, which are unreactive toward metallic lithium and toward lithium sulfides and lithium polysulfides. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, the separators selected may be separators made from PET nonwovens filled with inorganic particles. Such separators may have a porosity in the range from 40 to 55%. Suitable pore diameters are, for example, in the range from 80 to 750 nm.

Inventive rechargeable electrical cells are notable for particularly high capacities, high performance even after repeated charging, even under the action of mechanical stress on the cell, and significantly delayed cell death. Inventive rechargeable electrical cells are very suitable for use in automobiles, aircraft, bicycles operated by electric motor, for example pedelecs, ships or stationary energy stores. Such uses form a further part of the subject matter of the present invention.

The present invention also provides for the use of an ion- and electron-conductive metal chalcogenide for production of a rechargeable electrical cell as described above. According to the invention, the ion- and electron-conductive metal chalcogenide is processed together with carbon in a polymorph comprising at least 60% sp²-hybridized carbon atoms and at least one sulfur-containing component selected from the group consisting of elemental sulfur, a composite produced from elemental sulfur and at least one polymer, a polymer comprising divalent di- or polysulfide bridges, and mixtures thereof, and optionally further constituents to give an electrode, which is used as a component for production of a rechargeable electrical cell.

The invention is illustrated by the examples which follow but which do not restrict the invention. Figures in % are based on percent by weight, unless explicitly stated otherwise.

### I. Production of Electrode Material

### I.1 Production of an Aqueous Formulation of an Inventive Electrode Material E1

In a laboratory glass bottle, a solution of 0.25 g of polyvinyl alcohol in 60 g of a water-isopropanol mixture (weight ratio: 65:35) was prepared. To this solution were added 1.4 g of sulfur, 2.6 g of titanium(IV) sulfide, 1 g of carbon black 1 (Ketjen®, BET surface area: 900 m²/g (measured to ISO 9277), mean particle diameter: 10 μm) and 1 g of carbon black 2 (commercially available as Printex®, BET surface area: 100 m²/g (measured to ISO 9277), mean particle diameter: 10 μm), and the mixture was stirred. The suspension thus obtained was ground in a ball mill (Pulverisette 6 from Fritsch) with the aid of stainless steel balls at 300 rpm over a period of 30 minutes. After the removal of the stainless steel balls, an aqueous ink E1 was obtained, which had a creamy consistency.

### I.2 Production of an Aqueous Formulation of an Inventive Electrode Material E2

In a laboratory glass bottle, a solution of 0.25 g of polyvinyl alcohol in 60 g of a water-isopropanol mixture (weight ratio: 65:35) was prepared. To this solution were added 2.8 g of sulfur, 1.2 g of titanium(IV) sulfide, 1 g of carbon black 1 (Ketjen®, BET surface area: 900 m²/g (measured to ISO 9277), mean particle diameter: 10 μm) and 1 g of carbon black 2 (commercially available as Printex®, BET surface area: 100 m²/g (measured to ISO 9277), mean particle diameter: 10 μm), and the mixture was stirred. The suspension thus obtained was ground in a ball mill (Pulverisette 6 from Fritsch) with the aid of stainless steel balls at 300 rpm over a period of 30 minutes. After the removal of the stainless steel balls, an aqueous ink E2 was obtained, which had a creamy consistency.

### I.3 Production of an Aqueous Formulation of an Inventive Electrode Material E3

In a laboratory glass bottle, a solution of 0.25 g of polyvinyl alcohol in 60 g of a water-isopropanol mixture (weight ratio: 65:35) was prepared. To this solution were added 3.2 g of sulfur, 0.8 g of titanium(IV) sulfide, 1 g of carbon black 1 (Ketjen®, BET surface area: 900 m²/g (measured to ISO 9277), mean particle diameter: 10 μm) and 1 g of carbon black 2 (commercially available as Printex®, BET surface area: 100 m²/g (measured to ISO 9277), mean particle diameter: 10 μm), and the mixture was stirred. The suspension thus obtained was ground in a ball mill (Pulverisette 6 from Fritsch) with the aid of stainless steel balls at 300 rpm over a period of 30 minutes. After the removal of the stainless steel balls, an aqueous ink E3 was obtained, which had a creamy consistency.

### I.4 Production of an Aqueous Formulation of a Comparative Electrode Material C-E4

In a laboratory glass bottle, a solution of 0.25 g of polyvinyl alcohol in 60 g of a water-isopropanol mixture (weight ratio: 65:35) was prepared. To this solution were added 2 g of sulfur and 3.5 g of titanium(IV) sulfide and the mixture was stirred. The suspension thus obtained was ground in a ball mill (Pulverisette 6 from Fritsch) with the aid of stainless steel balls at 300 rpm over a period of 30 minutes. After the removal of the stainless steel balls, an aqueous ink C-E4 was obtained, which had a creamy consistency.

### I.5 Production of an Aqueous Formulation of a Comparative Electrode Material C-E5

In a laboratory glass bottle, a solution of 0.25 g of polyvinyl alcohol in 60 g of a water-isopropanol mixture (weight ratio: 65:35) was prepared. To this solution were added 3.5 g of titanium(IV) sulfide and 2 g of C and the mixture was stirred. The suspension thus obtained was ground in a ball mill (Pulverisette 6 from Fritsch) with the aid of stainless steel balls at 300 rpm over a period of 30 minutes. After the removal of the stainless steel balls, an aqueous ink C-E5 was obtained, which had a creamy consistency.

### II. Production of Electrodes

The aqueous formulations of electrode materials (E1, E2, E3, C-E4 and C-E5) obtainable from example I. were each used as follows for production of electrodes.

The respective ink was sprayed by means of an airbrush method onto aluminum foil (thickness: 30 μm) on a vacuum table (temperature: 75° C.). Nitrogen was used for spraying. A solids loading of 4 mg/cm² was achieved. Thereafter, the aluminum foil coated on one side was cautiously laminated between two rubber rollers. A low applied pressure was selected, in order that the coating remained porous. Subsequently, the aluminum foil coated on one side was treated thermally in a drying cabinet at a temperature of 40° C.

The inventive electrode materials E1, E2 and E3 were used to produce the inventive cathodes K1, K2 and K3, and the comparative electrode materials C-E4 and C-E5 to produce the comparative cathodes C-K4 and C-K5.

III. Testing of the electrodes as cathodes in electrochemical cells

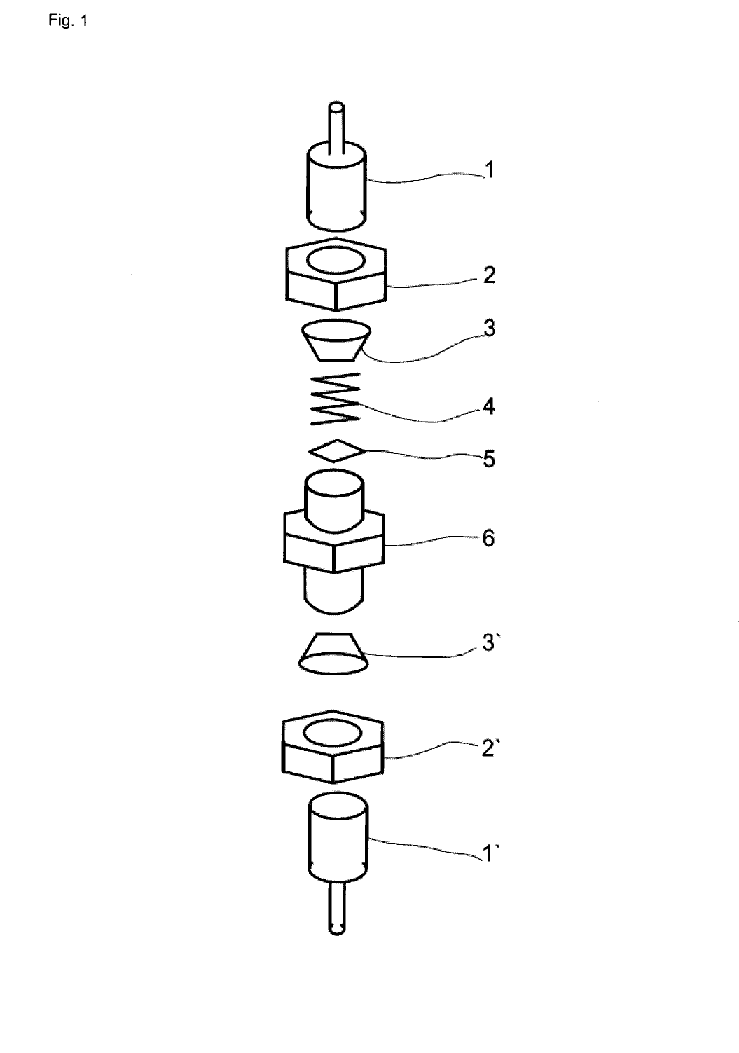

For the electrochemical characterization of the cathodes K1, K2, K3, C-K4 and C-K5 produced in example II., electrochemical cells according to FIG. 1 were constructed. For this purpose, as well as the cathodes produced in example II., the following components were used in each case:
Anode: Li foil, thickness 50 μm,
Separator: polyethylene film, porous membrane of thickness 15 μm
Cathode: according to example II.
Electrolyte: 8% by weight of LiTFSI (LiN(SO₂CF₃)₂), 2% by weight of LiNO₃, 45% by weight of 1,3-dioxolane and 45% by weight of 1,2-dimethoxyethane

The inventive cathodes K1, K2 and K3 were used to produce inventive cells Z1, Z2 and Z3, and comparative electrodes C-K4 and C-K5 to produce comparative cells C-Z4 and C-Z5.

FIG. 1 shows the schematic structure of a dismantled electrochemical cell for testing of inventive and noninventive electrode materials.

The annotations in FIG. 1 mean:
1, 1′ die
2, 2′ nut
3, 3′ sealing ring—two in each case; the second, somewhat smaller sealing ring in each case is not shown here
4 spiral spring
5 output conductor made from nickel
6 housing

The inventive electrochemical cells Z1, Z2 and Z3 exhibited an open circuit potential of 2.5 volts. During the discharge (C/5), the cell potential fell to 2.3 volts (1^{st} plateau) and then to 2.0 to 2.1 volts (2^{nd} plateau). The cells were discharged down to 1.8 V and then charged. During the charging operation, the cell potential rose to 2.2 volts, and the cells were each charged until 2.5 volts were attained. This was followed by a one-hour charging step at 2.5 volts. Then the discharge operation began again. The inventive electrochemical cells produced attained more than 50 cycles with a small loss of capacity.

TABLE 1
Test results for inventive and noninventive electrochemical cells

| | | S | TiS₂ | C | | | Loss of |
|---|---|---|---|---|---|---|---|
| Exam- | | % by | % by | % by | Cycle 5 | Cycle 40 | capacity |
| ple | S/TiS₂ | wt. | wt. | wt. | capacity* | capacity* | in % |
| Z1 | 35/65 | 23.3 | 43.3 | 33.3 | 542 | 464 | 14.39 |
| Z2 | 70/30 | 46.6 | 20 | 33.3 | 899 | 817 | 9.12 |
| Z3 | 80/20 | 53.3 | 13.3 | 33.3 | 992 | 932 | 6.05 |
| C-Z4 | 35/65 | 35 | 65 | 0 | 414 | 342 | 17.39 |
| C-Z5 | 0/100 | 0 | 63.6 | 37.4 | 167 | 142 | 14.97 |

The % by weight are based on the sum of the masses of S, TiS₂ and C used in the electrode material production, without taking into account any further constituents, for example binder or solvent residue.
*The capacity is reported in examples Z1, Z2, Z3 and C-Z4 in the unit of mAh per g of sulfur; in example C-Z5, the capacity is reported in the unit of mAh per g of titanium disulfide.

1. An electrode material for an electrical cell comprising
(A) at least one ion- and electron-conductive metal chalcogenide,
(B) carbon in a polymorph comprising at least 60% sp²-hybridized carbon atoms,
(C) at least one sulfur-containing component selected from the group consisting of elemental sulfur, a composite produced from elemental sulfur and at least one polymer, a polymer comprising divalent di- or polysulfide bridges and mixtures thereof, and
(D) optionally at least one binder.

2. The electrode material according to claim 1, wherein the proportion of the metal chalcogenide (A) is from 0.1 to 30% by weight, the proportion of the carbon (B) from 19 to 50% by weight and the proportion of the sulfur-containing component (C) from 20 to 80% by weight, where the percentages by weight are each based on the total mass of components (A), (B) and (C).

3. The electrode material according to claim 1 or 2, wherein the ion- and electron-conducting metal chalcogenide is selected from the group of the compounds consisting of CoTe₂, Cr₂S₃, HfS₂, HfSe₂, HfTe₂, IrTe₂, MoS₂, MoSe₂, MoTe₂, NbS₂, NbSe₂, NbTe₂, NiTe₂, PtS₂, PtSe₂, PtTe₂, SnS₂, SnSSe, SnSe₂, TaS₂, TaSe₂, TaTe₂, TiS₂, TiSe₂, TiTe₂, VS₂, VSe₂, VTe₂, WS₂, WSe₂, WTe₂, ZrS₂, ZrSe₂ and ZrTe₂.

4. The electrode material according to claim 1 or 2, wherein the ion- and electron-conductive metal chalcogenide is TiS₂.

5. The electrode material according to any of claims 1 to 4, wherein carbon (B) is selected from carbon black.

6. The electrode material according to any of claims 1 to 5, wherein the sulfur-containing component is elemental sulfur.

7. A rechargeable electrical cell comprising at least one electrode which has been produced from or using an electrode material according to any of claims 1 to 6.

8. The rechargeable electrical cell according to claim 7, which further comprises at least one electrode comprising metallic lithium.

9. The rechargeable electrical cell according to claim 7 or 8, which comprises a liquid electrolyte comprising a lithium-containing conductive salt.

10. The rechargeable electrical cell according to any of claims 7 to 9, which comprises at least one nonaqueous solvent selected from polymers, cyclic and noncyclic ethers, noncyclic and cyclic acetals and cyclic and noncyclic organic carbonates.

11. The use of an ion- and electron-conductive metal chalcogenide for production of a rechargeable electrical cell according to any of claims 7 to 10.

12. The use of a rechargeable electrical cell according to any of claims 7 to 10 in automobiles, bicycles operated by electric motor, aircraft, ships or stationary energy stores.
